(19) United States
(12) Patent Application Publication
(10) Pub. No.: US 2024/0152601 A1
(43) Pub. Date: May 9, 2024

(54) SYSTEM AND METHOD FOR BUILDING CUSTOMIZED TRUSTED EXECUTION ENVIRONMENTS WITH A SYSTEM-ON-CHIP FIELD PROGRAMMABLE GATE ARRAY

(71) Applicant: The Research Foundation for the State University of New York, Amherst, NY (US)

(72) Inventors: Ziming Zhao, Williamsville, NY (US); Md Armanuzzaman, Buffalo, NY (US)

(21) Appl. No.: 18/504,528

(22) Filed: Nov. 8, 2023

Related U.S. Application Data
(60) Provisional application No. 63/423,642, filed on Nov. 8, 2022.

(51) Int. Cl. G06F 21/53; G06F 21/57

(52) U.S. Cl. CPC G06F 21/53; G06F 21/575; G06F 2221/033

(57) ABSTRACT

A system and method for building a trusted execution environment for software programs in a system-on-chip (SOC) field programmable gate array (FPGA). A processing system is located on the semiconductor substrate of the SOC which includes one or more processors, and the FPGA is in communication with the processing system and implements one more soft processors to create one or more trusted execution environments for a software program process to execute within. Each trusted execution environment is configured to allow a software program to execute in a secure manner wherein the software program is isolated from, at least, the full plurality of computing resources of the SOC. The system and method can be used with SOCs on servers hosting remote computing.

### CROSS-REFERENCE TO RELATED APPLICATIONS

This application claims the benefit of U.S. Provisional Application No. 63/423,642, filed on Nov. 8, 2022, the entirety of which is hereby incorporated herein by this reference.

### STATEMENT REGARDING FEDERALLY SPONSORED RESEARCH

This invention was made with government support under grant number 2037798 awarded by the National Science Foundation. The government has certain rights in the invention.

### BACKGROUND OF THE INVENTION

### 1. Field of the Invention

The present invention generally relates to computation and communication between remotely located computers. More particularly, the present invention relates to a system and method for creating a trusted environment for execution of potentially harmful software programs in a system-on-chip field programmable gate array (FPGA).

### 2. Description of the Related Art

In remote computing, users transmit their own data to a remote application and receive its result. The significant benefit that users expect from remote computing is that they can perform a broad spectrum of computations—from small to large scale—directly on the remote site at lower costs and with better performance than on their own facilities. Cloud technology is one example of large-scale remote computing.

Cloud computing technology gives users remote access to storage, software, and computing devices (such as servers) through internet-connected devices. Through cloud computing, users have the ability to store and access data and programs over the internet instead of using local resources. However, with the growing popularity of remote computing services, security is becoming an ever-increasingly important issue for service providers and users.

For instance, in one type of cloud, Software-as-a-Service (SaaS), everything, including applications and remote user data, is managed by the cloud server. It is known that data security compliance issues are somewhat intrinsic to these types of cloud or remote computing mainly because the privacy and integrity of user data are built on the trust in the remote server. Specifically, as the server (or its administrator) normally has to manage all computing resources in the system, it is entrusted with the full privilege of controlling access to private data belonging to users. Unfortunately, any server dealing with private data entrusted by remote owners innately entails a security risk, called an “insider threat,” which comes from a privileged insider (i.e., administrator) of a server who turns into an adversary trying to steal or tamper with clients' data. It is estimated that about a third of cyberattacks are suspected to be the result of insider threats.

A well-known solution to thwart such threats by insiders is building a trusted execution environment (TEE) within a server for remote users. The TEE aims to ensure the privacy and integrity of user code and data loaded on the server. Applications loaded in the TEE are guaranteed to run and process data in an isolated environment securely from the rest of the host system, namely the rich execution environment (REE), administered by privileged insiders. Private user data are stored in secure storage shielded from the REE, and sensitive functions are executed inside a TEE without interference from the REE. Therefore, even if malicious insiders have full control over the REE, in principle, they cannot corrupt or leak remote user data processed inside a TEE.

Examples of hardware-assisted TEEs on commodity computing devices make use of hardware security primitives offered by the CPU, such as Intel® SGX and Arm® TrustZone®, to guarantee code and data loaded inside to be protected, with respect to confidentiality and integrity, from the Rich Execution Environment (REE). In recent years, there has been significant growth in using SGX and TrustZone in real-world products and academic projects, which include real-time kernel protections, securing containers and runtime libraries, and shielding applications from attacks. However, the hardware and software of existing TEEs have several problematic issues making them either ineffective or inefficient in use.

For example, these extant TEEs only provide one isolated execution environment with a static and fixed hardware Trusted Computing Base (TCB), which cannot be customized for different applications. For example, in TrustZone, only the TEEs that have the highest privilege and can control all peripherals, and for SGX, it means applications in enclaves have to go through the REE OS to communicate with peripherals. Another problem with extant TEEs is it shares a processor core with the REE in a time-sliced fashion, making it vulnerable to cache side-channel attacks.

A further problem with extant TEEs is that the context switches between the TEE and REE are expensive, costing many CPU cycles. Further, the software TCBs in TEEs are large, creating big attack surfaces for run-time attacks that hijack the control or data flow. For example, Haven places a whole Windows 8 library OS inside the enclave. OP-TEE, a Cortex-A secure world OS, has 277K source lines of code (SLOC), and TF-M, a trusted firmware for Cortex-M TrustZone, also over 117K SLOC.

Moreover, the TEE is one not secured via encryption or other methods against insider threat. For example, TrustZone does not encrypt the contents on Dynamic RAM (DRAM) at anytime, and the memory for an SGX enclave is decrypted for code running from within the enclave TEE itself. Therefore, both of these are subject to code and data disclosure from cold boot attacks.

The present invention therefore addresses this problem of the efficient scalability and usability of TEEs in large-scale remote computing environments, such as cloud computing applications. Furthermore, the present invention addresses the security problems of TEEs being vulnerable to insider threats.

### BRIEF SUMMARY OF THE INVENTION

Briefly described, the present system and method are for building a trusted execution environment for software programs, especially in a remote computing environment. The system and method use a system-on-chip (SOC), which is a semiconductor substrate including a plurality of electronic components with a plurality of computing resources on that substrate. The invention uses a processing system located on the semiconductor substrate that includes one or more processors, and a field programmable gate array (FPGA) located on the semiconductor substrate and in communication with the processing system. The FPGA, in one embodiment, is configured to implement one more soft processors to create one or more trusted execution environments (TEEs) for a software program process to execute within, with each TEE configured to allow a software program to execute in a secure manner wherein the software program is isolated from, at least, the full plurality of computing resources of the semiconductor substrate. It is preferred that the isolation of the TTE be physical from the other resources of the SOC.

In one embodiment, the FPGA is comprised of block random access memory, and can be further configured with a bitstream programmed in a hardware design description language. In another embodiment, where the isolated software program includes firmware, the FPGA is further configured to support a secure boot wherein a software program is loaded onto the processing system and the bitstream, with any firmware within the software program loaded onto the FPGA in a TEE. The FPGA can also include a cryptographic layer.

The semiconductor substrate can be within a server hosting one or more data processes from remote users, such as is present in cloud computing. And, in one embodiment, the bitstream implements a graphics processing unit module, such that the TEE is a “general-purpose computing on graphics processing units” (GPGPU) environment.

The inventive method for building a trusted execution environment for software programs can include configuring a plurality of computing resources on a SOC semiconductor substrate including a plurality of electronic components, configuring a processing system located on the semiconductor substrate including one or more processors, configuring a FPGA that is located on the semiconductor substrate and in communication with the processing system, the FPGA configured to implement one more soft processors to create one or more TEEs for a software program process to execute within, and configuring each TEE to allow a software program to execute in a secure manner wherein the software program is isolated from, at least, the full plurality of computing resources of the semiconductor substrate. The method can include further configuring the FPGA within a block random access memory, and further configuring the FPGA with a bitstream programmed in a hardware design description language.

In another embodiment, the method can further include configuring the FPGA to support a secure boot of a software program that includes firmware by loading that software program onto the processing system and the bitstream, and loading any firmware within that software program onto the FPGA in a TEE. The method can also include configuring the FPGA to include a cryptographic layer.

In one embodiment, where the semiconductor substrate is within a server, the method includes hosting one or more data processes at the server from remote users, and then implementing a graphics processing unit module within the bitstream. Then the method further includes implementing a GPGPU environment as the TEE.

The present invention is therefore advantageous and industrially applicable in that it provides a hardware and software codesign infrastructure to on commodity SCC FPGA devices without any hardware changes. Using the inventive system, developers can build multiple equally secure customized TEEs (CTEE) on demand with configurable hardware and software TCBs to execute their Security-Sensitive Applications (SSA). A CTEE only includes the hardware and software functionality necessary for the SSA and excludes other hardware and software components on the system. Furthermore, the present invention can provide a TEE specialized for remote computing on a FPGA, which allows physical isolation from a would-be malicious CPU or other harmful processes.

### BRIEF DESCRIPTION OF THE DRAWINGS

FIG. 1 is a system diagram of one embodiment of the SOC with a processing system and FPGA.

FIG. 2 is a diagram illustrating the architecture and workflow of the TEE framework at development-time, boot- and run-time.

FIG. 3 is a diagram illustrating static and dynamic trust bootstrap paths.

FIG. 4 is a diagram illustrating a SSA Execution Block (SEB) layout, simplified CTEE address space layout, and steps in executing an SSA.

FIG. 5 is a diagram illustrating the execution of two SSAs concurrently on two CTEEs.

FIG. 6 is a diagram illustrating the execution of two SSAs sequentially on one CTEE.

FIG. 7 is a diagram of Hardware TCB size and resource utilization of CTEEs for the example SSAs on Cora Z7-07S.

FIG. 8 is a visual diagram of DRAM decay after power down and BRAM hardware initialization after power up on the same Z7-07S board.

### DETAILED DESCRIPTION OF THE INVENTION

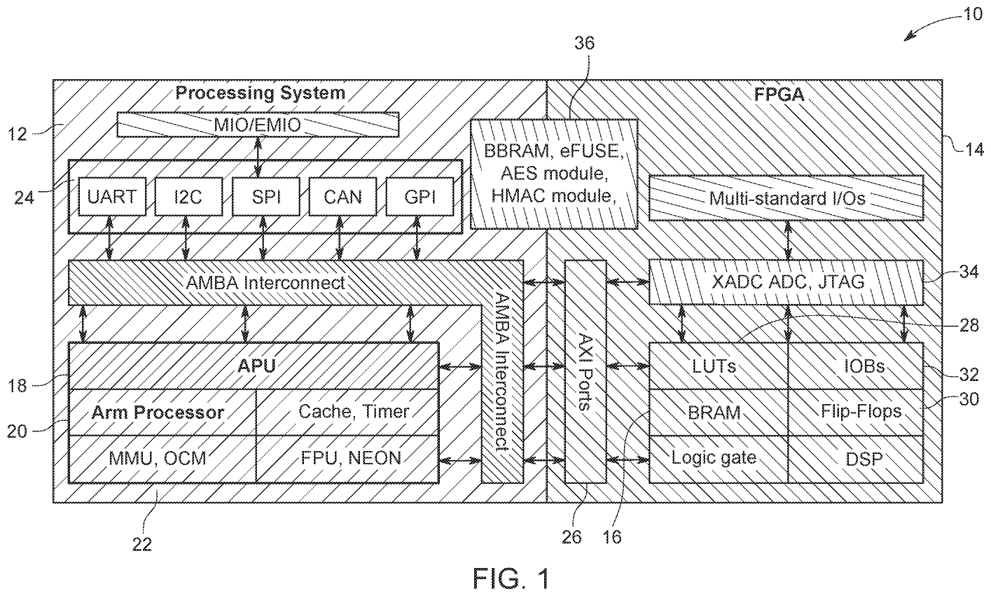

With reference to the figures in which like numerals represent like elements throughout the several views, FIG. 1 is system diagram of one embodiment of the SOC 10 with a processing system 12 and FPGA 14. Here, a Xilinx Zynq-7000 SoC FPGA hardware component is utilized. Here, the SOC 10 implements the functionality of an entire system on a single silicon substrate. Compared with system-on-printed-circuit-board, SoC is a lower cost, enables more secure data transfers, and has higher speed and lower power consumption. However, traditional application-specific integrated circuit typically SoCs lack flexibility, making them suitable only for products with a limited lifetime. A SoC FPGA is a type of flexible system-on-programmable-chip, where FPGAs 14 can be reconfigured as desired.

A SoC FPGA comprises the following parts: 1) Processing System (PS 12), which is formed around hard processors, such as the Cortex-A processor on Xilinx Zynq-7000 SoC. Traditional operating systems and applications run on the PS 12; 2) An FPGA 14, which can implement any arbitrary system, including soft processors, e.g., Cortex-M, MicroBlaze, etc., high-speed logic, arithmetic, and data flow subsystems. In addition to the general fabric, the FPGA 14 has Block RAMs (BRAM 16) to store data. Note that BRAM 16 is made of Static RAM (SRAM). Compared to DRAM whose cells are made of capacitors and is vulnerable to cold boot attacks due to the slow decay, BRAM 16 decays faster. The FPGA 14 is configured with a bitstream, which is programmed in hardware design description languages, such as Verilog, VHDL, etc.; 3) other integrated on-chip memory and high-speed communications interfaces.

More specifically, FIG. 1 shows the architecture with Application Processing Unit (APU) 18 is the main building block of the PS module, which consists of a single or dual-core Arm Cortex-A processor 20, Memory Management Unit (MMU) 22, On-Chip Memory (OCM), caches, etc. Additionally, the PS 12 module connects external I/O interfaces 24, such as SPI, I2C, UART, etc. To connect the PS 12 and FPGA 14 interfaces, the PS 12 module includes Advanced eXtensible Interface (AXI) 26 interconnects. The FPGA 14 side is mainly composed of configurable logic blocks, Lookup Tables (LUT) 28, flip-flops 30, switch matrix, carry logic, BRAM, and Input/Output Blocks (IOB) 32 for interfacing. The FPGA 14 also includes modules for Analogue to Digital Conversion (ADC) 34 and a set of JTAG ports for configuration and debugging. Several security modules are connected to both the PS 12 and FPGA 14, such as secure storage 36 (Battery-backed RAM and eFUSE), cryptographic accelerators (AES, HMAC, RSA, etc.).

It can thus be summarized that system uses a system-on-chip (SOC), such as SOC 10, which is a semiconductor substrate including a plurality of electronic components (such as PS 12 and FPGA 14) with a plurality of computing resources on that substrate. The invention uses a processing system 12 located on the semiconductor substrate that includes one or more processors, such as APU 18, and a FPGA 14 located on the semiconductor substrate and in communication with the processing system 12, such as through AXI ports 26. The FPGA 14, in one embodiment, is configured to implement one more soft processors to create one or more trusted execution environments (TEEs), as discussed further herein, for a software program process to execute within, with each TEE configured to allow a software program to execute in a secure manner wherein the software program is isolated from, at least, the full plurality of computing resources of the semiconductor substrate. It is preferred that the isolation of the TTE be physical from the other resources of the SOC 12.

In one embodiment, the FPGA 14 includes a block random access memory 16, and can be further configured with a bitstream programmed in a hardware design description language. In another embodiment, where the isolated software program includes firmware, the FPGA 14 is further configured to support a secure boot wherein a software program is loaded onto the processing system and the bitstream, with any firmware within the software program loaded onto the FPGA 14 in a TEE. The FPGA can also include a cryptographic layer, as is further described herein.

The semiconductor substrate can be within a server hosting one or more data processes from remote users, such as is present in cloud computing. And, in one embodiment, the bitstream implements a graphics processing unit module, such that the TEE is a “general-purpose computing on graphics processing units” (GPGPU) environment, which is further described herein.

A typical design and development flow of systems running on SoC FPGA 10 involves: i) the development of the hardware system on the FPGA 14, including design of the peripheral blocks and creating the connections between these blocks and the PS 12. A developer can use hardware IP blocks from standard design tool libraries; ii) the development of the software system on the PS 12 and the FPGA 14 soft processor. To be compatible with SoCs without FPGAs, when a SoC FPGA 10 device is powered on, the PS 12 boots first before going on to configure the FPGA 14.

Without loss of generality, we use a Xilinx Zynq device as an example to explain the secure boot sequence. To enable secure boot, unique AES and RSA keys are generated off the device and programmed to the persistent secure storage, e.g., eFUSE array 36, on the device. The keys are used to encrypt and sign the bitstream and the firmware (in ELF format) that runs on the software core in the development stage. The device first starts with the hard-wired boot ROM, which verifies, decrypts, and loads the First Stage Boot Loader (FSBL) from supported interfaces, such as SD card, JTAG 34, etc. The FSBL, in turn verifies and sets up the FPGA 14 with bitstream using the device configuration (DevC) interface and firmware, after which the firmware on FPGA starts execution. The FSBL also verifies the Second Stage Boot Loader (SSBL), such as U-Boot, and gives control of the PS 12 to it. U-Boot verifies and boots the operating system on PS 12. In addition to boot time configuration, some FPGAs 14 can also be programmed at run-time to replace the contents with an updated design. For instance, software running on the PS 12 of some Xilinx Zynq devices can use the DevC and Processor Configuration Access Port (PCAP) interfaces to reconfigure the whole or part of the FPGA.

In the present embodiment of the system model, the SoC FPGA 10 supports secure boot, which loads the software images onto the PS 12 and the bitstream and firmware onto the FPGA 14 after integrity checks at boot-time. At the hardware level, the DRAM is connected to the PS 12 and FPGA 14, and some peripherals can be connected to the FPGA 14 without routing through the PS 12. The former enables the PS 12 and FPGA 14 modules to communicate efficiently via shared memory, and the latter makes sure the software on the PS 12 cannot eavesdrop or tamper any data between the FPGA 14 and peripherals.

At the cryptographic layer, each SoC FPGA 10 has a device key, e.g., AES (k_{d}), RSA (sk_{d}; pk_{d}), which are used to encrypt/decrypt and sign/verify software images, bitstream, and the firmware. The device keys are unique to each device and are programmed in the eFUSE 36 or BBRAM using hardware interfaces with physical access. In this embodiment, a developer can be identified by a developer key, e.g., RSA (skᵤ; pkᵤ), which the developer uses to encrypt and sign the SSAs, and the firmware uses it to decrypt and verify the SSAs. Developer public keys are either embedded into the firmware at the development stage or loaded into the firmware at run-time.

In one threat model, one assumes the adversary can compromise and take full control of the software system of the PS 12 at run-time, which means the kernel and privileged software in the secure world of a TrustZone-based system can be malicious. The compromised software on the PS 12 can send arbitrary data to the firmware and SSAs via shared DRAM regions and also to the CTEE hardware pins, such as interrupts. Attackers can perform cold-boot attacks to dump the content in DRAM, but cold-boot attacks on BRAM 16 (SRAM) are difficult. Denial-of-Service (DoS) attacks against TEE are possible, but compromised PS 12 software resets the entire system, making the CTEEs not available. Further, compromised PS 12 software reconfigures the FPGA 14 at run-time, and then the whole system is physically reset. While DoS attacks cannot be prevented in the current system, they can be detected via proof-of-execution.

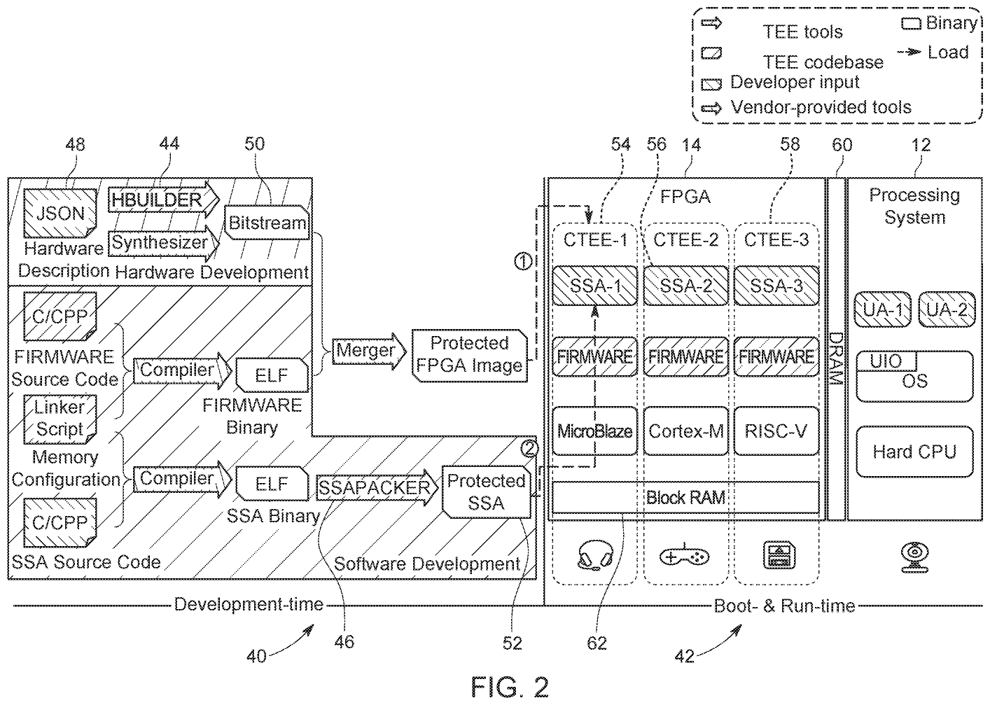

FIG. 2 is one embodiment of an architecture and workflow of the TEE framework at development-time 40, boot- and run-time 42. During development, TEE and vendor-provided tools can be used to generate the protected FPGA 14 image and protected SSAs, which are loaded onto the FPGA 14 and in CTEEs, respectively. In this run-time architecture example, three CTEEs with different hardware configurations, including CPU and peripheral, are presented. An untrusted applications access the shared DRAM region through a userspace I/O interface (UIO). In this embodiment, the TEE tools and codebase mainly include the HARDWAREBUILDER 44, FIRMWARE, and SSAPACKER 46. During the development stage, the HARDWAREBUILDER 44 generates synthesizer commands, e.g., Tcl, based on the SSA's needs specified in the developer's hardware description JSON input 48. Then, the SoC FPGA 10 vendor-provided synthesizer, e.g., Xilinx Vivado, generates the bitstream 50 file using the synthesizer commands. The developer customizes the FIRMWARE by only including the needed source code and writes the SSA source codes, which are compiled using the vendor-provided compiler, e.g., mb-gcc for MicroBlaze. The bitstream 50 and the FIRMWARE binary are encrypted, signed, and packed by the vendor-provided merger, e.g., UpdateMEM from Xilinx, into a protected FPGA 14 image.

The SSA binary is encrypted, signed, and packed by the SSAPACKER 46 into a protected SSA 52. At boot-time, the bitstream 50 is loaded onto the FPGA 14. As a result, multiple CTEEs 54,56,58 are created and the corresponding FIRMWARE starts running, respectively. Then, a UA can trigger the loading of a protected SSA into a CTEE. The FPGA 14 is configured to build CTEEs. Each CTEE has its own set of hardware, including softcore CPU, e.g., MicroBlaze, CortexM, etc., Block RAM, and peripherals. With FPGA 14 routing, these hardware resources within a CTEE are connected together but isolated from the PS 12 and other CTEEs. The softcore CPU in a CTEE is not time-shared with the PS and other CTEEs, mitigating the cache side-channel attacks. No additional hardware modules, such as debuggers, can be connected to a CTEE unless it is explicitly specified by the developer. The connections among these resources are also physically isolated from the PS 12 and other CTEEs, preventing eavesdropping and tampering. CTEEs use interrupts on softcore CPU and shared physical memory regions on the DRAM 60 to communicate with the PS 12, whereas CTEEs use interrupts and shared regions on the BRAM 62 to communicate with each other. Hardware configuration alone, however, cannot meet all the design goals. The TEE includes FIRMWARE, which can be customized and only consists of libraries, a HAL for the needed peripherals, and a loader for the SSA. The FIRMWARE also provides softcore CPU interrupt-based remote attestation mechanisms for proving the integrity and execution of SSAs.

To customize the hardware TCB, the developer can design one or more CTEEs using a hardware description language, e.g., Verilog or HDL. The output is a bitstream file that configures the FPGA. To facilitate this step, TEE has a component, named HARDWAREBUILDER 44, which takes developer-specified hardware description in JSON 48 format as input, allocates hardware resources, and outputs a script, e.g., in Tcl format, that can be processed by a synthesis tool, e.g., xilinx Vivado, to generate the bitstream. Each CTEE's hardware description includes but is not limited to: i) a softcore CPU, e.g., MicroBlaze, Cortex-M0, etc., and its configurations, e.g., clock frequency and cache size; ii) a corresponding debug IP to enable software debugging on the softcore CPU; iii) its main BRAM 62 memory address and size; iv) the address and size of the shared DRAM 60 with the PS; v) the address and size of the shared BRAM 62 with other CTEEs; and vi) connected peripherals. The HARDWAREBUILDER 44 assigns a continuous address space of the BRAM 62 to each CTEE and connects the hardware components automatically.

Thus, the TEE supports FPGAs 14 that can be configured at boot time and/or re-configured at run-time by providing trust bootstrap in CTEEs both statically and dynamically. The static trust bootstrap builds on secure boot, whereas the dynamic trust bootstrap relies on a trusted module at run-time.

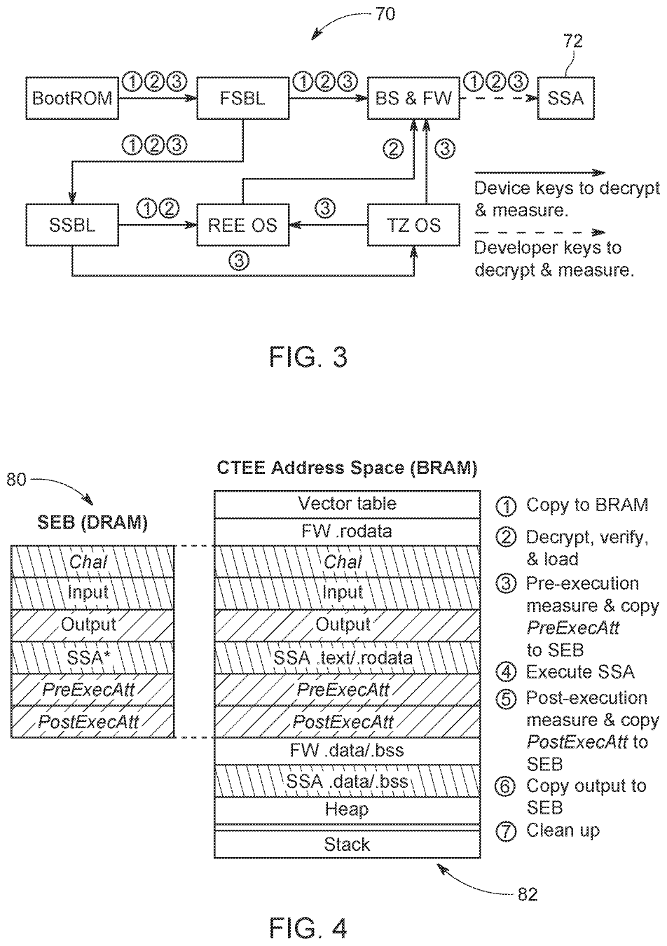

FIG. 3 is a diagram 70 of static and dynamic trust bootstrap paths on Xilinx Zynq SoC. Illustrated is static trust bootstrap 1, dynamic trust bootstrap without TrustZone. 2, and dynamic trust bootstrap with TrustZone 3. Without loss of generality, FIG. 3 shows three paths for static and dynamic trust bootstrap on the Xilinx Zynq SoC with Arm hard CPUs. In the static bootstrap 1, the TEE relies on secure boot to launch CTEEs. Device keys, e.g., AES key k_{d} and/or RSA public key pk_{d}, can be burned into some secure storage, e.g., eFUSE or BBRAM (36 in FIG. 1), before boot. BootROM, which is the root of trust for measurement, first decrypts, measures, and executes the FSBL using the device keys.

The FSBL initializes the PS 12 and FPGA 14 by i) decrypting, measuring, and executing the SSBL using the device keys; ii) decrypting, measuring, and configuring the FPGA 14 using the device keys, after which bitstream is programmed on the FPGA 14, and FIRMWARE starts execution. The FIRMWARE uses the developer keys, e.g., kᵤ and/or pkᵤ, to decrypt and measure the SSA. Allowed developer keys are embedded in the FIRMWARE at the development stage. Because the FIRMWARE is encrypted at rest and only decrypted on the BRAM 36, the developer keys are secure.

To create an SSA, the developer links the source code against the FIRMWARE. After the launching of a CTEE, the FIRMWARE initializes the softcore CPU and other components, then it waits for requests from the PS 12 side. Both the FIRMWARE and SSA 72 use a shared DRAM region in the SSAExecution Block (SEB) format as shown in FIG. 4, to have two-way data transmissions with UA on the PS 12. To initiate the transmission from the PS 12 to a CTEE, UA on the PS 12 raises interrupts on the CTEE's softcore CPU, which are handled by the FIRMWARE. The TEE defines three service primitives through interrupts: i) load and execute an SSA (LdExec); ii) load and execute an SSA with pre-execution attestation (LdExecPreAtt); iii) load and execute an SSA with post-execution attestation (LdExecPostAtt). The softcore CPU interrupts can be implemented as GPIO interrupts in the CTEE and memory-mapped to a DRAM address for the UA to access.

FIG. 4 is a diagram illustrating a SSA Execution Block (SEB) 80 layout, simplified CTEE address space 82 layout, and steps in executing an SSA 72. To execute an SSA 72 on a CTEE, the UA on the PS 12 first fills data into the SEB 80 and raises a LdExec* interrupt. As shown in FIG. 4, a SEB has regions for the encrypted and signed SSA 72 (SSA*), input data for the SSA 72, output data from the SSA 72, a challenge Chal from a remote verifier, a pre-execution (PreExecAtt), a post-execution attestation measurement (PostExecAtt) and other data. When the FIRMWARE receives a LdExec* interrupt, it copies SSA* and optionally Chal and input data in the SEB 80 from DRAM 60 (FIG. 2) to its own BRAM 16 (step 1). The FIRMWARE can also disable LdExec* interrupts after the data copying. Note that it is critical for the FIRMWARE to perform measurement on the BRAM 16 since the DRAM 60 can be changed asynchronously by the PS 12. The FIRMWARE then decrypts and verifies the encrypted SSA* using the corresponding developer's keys (step 2). Upon the successful verification of the SSA's 72 integrity, the FIRMWARE loads sections of the decrypted SSA 72 to the right locations and gives the control to the SSA 72 (path 5). If there is an output, the SSA 72 writes it in the output region on the BRAM 16 and yields the control of the softcore CPU back to the FIRMWARE. The FIRMWARE copies the output from the BRAM 16 to the DRAM 60 (step 6). Finally, the FIRMWARE cleans up all the input, output and SSA-related regions on the BRAM 16 and awaits new requests from the PS 12 (step 7).

In the dynamic cases, software running on the PS of a Xilinx Zynq device can use the device configuration (DevC) or Processor Configuration Access Port (PCAP) interfaces to reconfigure the FPGA 14. Therefore, the software module that reconfigures the FPGA 14 needs to access the device key and must be trusted. In the case that TrustZone is not available or used, as shown in path 2, the trusted software module can be part of the REE kernel, which uses the device keys to decrypt and measure the bitstream and FIRMWARE. If TrustZone is available, as shown in path 3, the trust software module can be a kernel module inside the TrustZone secure world operating system.

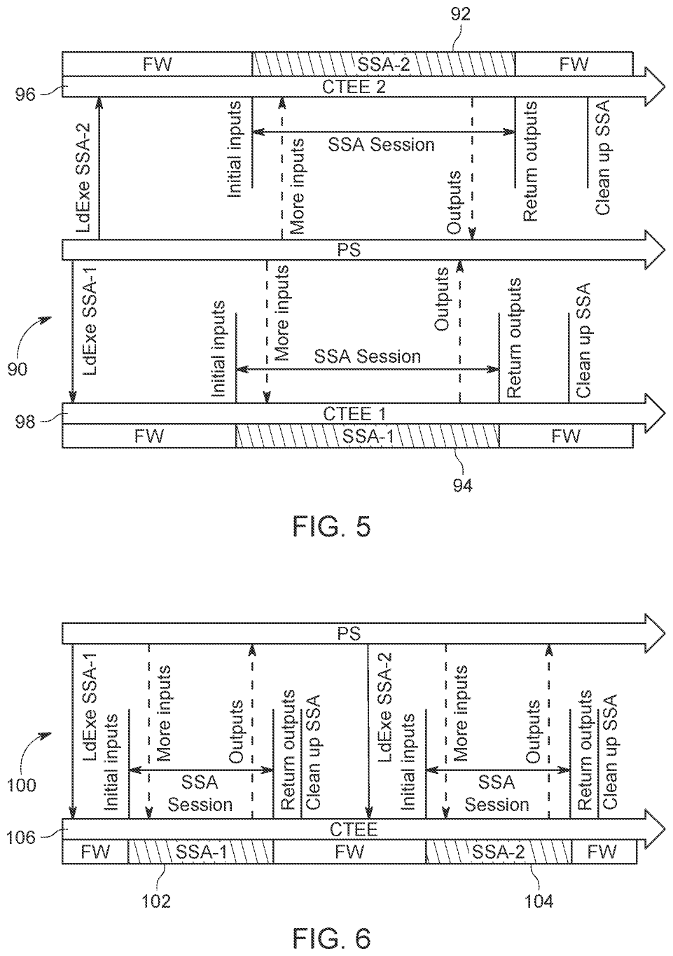

FIG. 5 is a diagram 90 illustrating the execution of two SSAs 92,94 concurrently on two CTEEs. FIG. 5 illustrates the timeline of two SSA executions concurrently on two CTEEs and the interactions between an UA on the PS and the CTEEs. Besides executing multiple SSAs on different CTEEs 96,98, the FIRMWARE also supports executing multiple SSAs 92,94 sequentially or the same SSA multiple times on the same CTEE without re-configuring the FPGA 15 as shown in FIG. 6.

FIG. 6 is a diagram 10 illustrating the execution of two SSAs 102,104 sequentially on one CTEE 106. Accordingly, in such embodiment, it is important for the FIRMWARE to clean up the BRAM (step 7, FIG. 4) after each SSA execution.

A TEE can provide two attestation mechanisms, namely preexecution and post-execution attestations, with reference again to FIG. 4. The former is equivalent to the traditional remote attestation of code and input integrity, whereas the latter is a form of proof of execution and output data integrity attestation. Note that the TEE only provides the mechanism for attestation, which can support sophisticated attestation protocols

In one embodiment of pre-execution attestation, a verifier sends a cryptographic nounce as Chal, which is copied to the BRAM 16 by the FIRMWARE (step 1, FIG. 4). After loading the SSA sections to the right addresses, the FIRMWARE computes a measurement PreExecAtt on Chal, input data and SSA read-only sections (step 3, FIG. 4), and copies the measurement to the DRAM 60. Depending on scenarios and attestation protocol details, the FIRMWARE can use a device key, developer key or other shared keys to compute the measurement. In post-execution attestation, the Chal from Vrf is also copied to the BRAM by the FIRMWARE (Step 1). After the SSA finishes execution (step 4), the FIRMWARE computes a measurement PostExecAtt on Chal, input data, output data generated by the SSA 72 and SSA's read-only sections, and copies the measurement to the DRAM (Step 5).

In the case that the UA on the PS 12 needs to continuously send input data to the SSA 72, e.g., not all input data is available at the beginning, the size of input in SEB 80 is not big enough, etc., the UA writes the newly available input data in the input region inside the SEB 80, and it can use two mechanisms to notify the FIRMWARE and SSA 72 that new data is available. The first mechanism works for softcore CPUs that support priority interrupts. On such systems, BYOTEE defines a NewData interrupt, which UA can raise. The NewData interrupt has a low priority so that it cannot interrupt the execution of the SSA 72. Only after the SSA 72 finishes execution and yields the control back to the FIRMWARE, the FIRMWARE can copy and measure the input data from the DRAM 60 to the BRAM 16, and gives the control to the SSA 72 again. On softcore CPUs without priority interrupts, the FIRMWARE uses global variables to indicate whether new data is available in the input region to synchronize with the SSAs on the CTEEs.

One advantage of the present inventive system and method is combat malicious software executing on the processing system 12. The PS 12 software, including the operating system and UA, is not a part of the TCB in the present TEE. Even if the PS 12 software is compromised at run-time, the attacker cannot access the data on/from CTEE hardware resources, including BRAM 16 and peripherals. The attacker cannot breach the confidentiality of SSA code and data as well, because they are encrypted at build time. The PS-CTEE 2-way communication is based on interrupts and the shared DRAM 16. Malicious PS 12 software can raise the interrupt to the CTEE to carry out a DoS attack. Utilizing priority interrupts in sophisticated softcore processors, the present TEE can prevent these attacks from the PS 12 side.

The present invention can also combat “cold-boot” attacks that rely on the observation that the contents in memory are not immediately erased after power is lost. While cold-boot attacks on DRAM 60 even at room temperature have proven very effective, attacks on SRAM without external power sources have been less practical. Most data the present TEE stores on DRAM 60 is either encrypted or does not need to be protected. For instance, even if the SEB 80 is located on the DRAM 60 and subject to cold-boot attacks, the SSA*, which includes developer keys, is encrypted. The Chal, PreExecAtt, PostExecAtt threads do not need to be protected. It is, however, possible to dump the input and output fields of the SEB 80 using cold-boot attacks on DRAM 60. Other sensitive data, such as developer keys, plaintext SSA, program states, are placed on a CTEE's BRAM 16. Cold-boot attacks on CTEEs' BRAM 16 are difficult for three reasons: i) the BRAM cells are hardware initialized during FPGA 14 configuration in many SoC FPGA 10 systems; ii) even without initialization, the contents in BRAM 16 decays faster; ii) BRAM 16 is embedded on chip and cannot be physically taken out, so attackers have to bypass software protections, including secure boot, to run a malicious software to dump its content.

Another common method of attack are “side-channel” attacks. Because the CPU is time-shared between the REE and TEE in SGX and TrustZone, cache side-channel attacks are effective in breaking their security promises. In the present TEE, the REE (PS 12) and CTEEs do not time-share any CPU resources; hence, there is no cache side-channel between the REE and TEEs.

In another embodiment, the TEE framework can be constructed on a Xilinx Zynq-7000 SoC FPGA and evaluated on a Digilent Cora Z7-07S development board. On the hardware side, one can use a Cora Z7-07S development board with a single-core 667 MHz Arm Cortex-A9 processor with 512 MB DDR3 memory, 32 KB L1 cache, 512 KB L2 cache and a Xilinx Zynq-7000 FPGA for evaluations. The Xilinx Zynq-7000 FPGA has 14,400 LUTs, 6,000 LUTRAM, 28,800 flip-flops, a 225 KB BRAM, 66 Digital Signal Processing (DSP) slices, and 100 IOBs. The development board also has an SPI header, two push-buttons, two RGB LEDs, a microSD card slot, two Pmod connectors, etc. Connect a Pmod I2S2 stereo audio input and output device to the board for SSA-3.

On the software side, one can create two partitions, namely boot and root, on an SD card and use the Xilinx bootgen tool to generate device boot images. Bootgen stitches a stock FSBL for the PS and the protected FPGA 14 image together to create a binary boot file. The boot file, U-Boot as the SSBL for the PS 12, and a PetaLinux image for the PS 12 are stored in the boot partition, whereas the protected SSAs, UAs, and other application files are stored in the root partition.

The present TEE infrastructure and toolchain, which include HARDWAREBUILDER, SSAPACKER, and FIRMWARE, can be implemented on the Xilinx Zynq-7000 SoC FPGA. The HARDWAREBUILDER was developed in Python (2.5K SLOC). The SSAPACKER include Python (63 SLOC) and C code (420 SLOC). The FIRMWARE was developed for the MicroBlaze processor in C, and the full FIRMWARE has an SSA loader and cleaner (1.1K SLOC), an attestation module (333 SLOC), an interrupt initialization and handling module (101 SLOC), and a linker script (212 lines). The FIRMWARE is linked against the vendor-provided HAL (7.9K SLOC) and libraries, e.g., libc (1.2 MB), etc. The FIRMWARE, especially the HAL, can be customized to reflect an SSA's needs. Our implementation of the SSA loader uses AES-256 bit for SSA encryption and SHA512-HMAC to protect the integrity and authenticity of SSAs. We use the BLAKE2 hash algorithm to implement the pre-execution- and post-execution attestations of SSA applications in the attestation module. On the PS side, a userspace I/O interface is used for the UAs to access the shared DRAM region between the PS and FPGA.

The BYOTEE toolchain also includes scripts to automate the steps from synthesizing the hardware from the Tcl scripts, compiling SSAs and FIRMWARE, formatting the SD card with partitions, and copying the files to the correct locations. In one embodiment, the hardware for each SSA in § 6.2 and used the HARDWAREBUILDER and synthesizer to generate its CTEE bitstream, e.g., CTEE-1 for SSA-1. All the CTEEs are configured with a 32-bit Microblaze CPU (ver-sion 10.0, 100 MHz, no instruction/data cache). The CTEE-1, CTEE-2, CTEE-3 have a 128 KB BRAM, whereas CTEE-4 has a 32 KB BRAM as their main memory. The peripherals that belong to a CTEE are connected through a dedicated AXI Interconnect IP.

The hardware designs can be implemented Z7-07S device. These figures demonstrate the configurable nature of the BYOTEE hardware TCB and the physical isolation of the CTEEs from each other and from the hardcore processor. The hardware design can include a debugger, which developer can use to debug the SSA and FIRMWARE on the softcore, whereas all other designs do not necessarily need to have a debugger for the minimum hardware TCB.

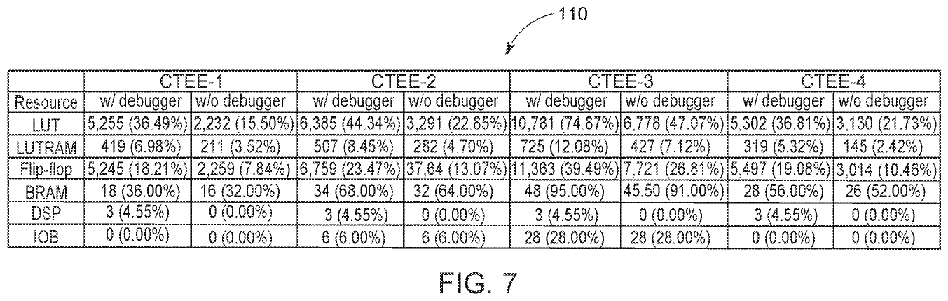

FIG. 7 presents each CTEE's hardware TCB and resource utilization on the Cora Z7-07S board with and without a debugger IP. As the table shows, the debugger IP significantly increases the resource utilization of a CTEE as it uses three DSP slices, two BRAMs, and many other resources. Since SSA-1 and SSA-4 do not use peripherals, CTEE-1 and CTEE-4 do not have any 10B.

Table 2 presents the size of the software TCB for the four example SSAs and their corresponding FIRMWARE.

TABLE 2

| | SSA | | Corresponding FIRMWARE | | | | |
|---|---|---|---|---|---|---|---|
| | SLOC | Bytes | SLOC | .text | .data | .bss | Total |
| SSA-1 | 717 | 12,892 | 3,143 | 27,296 | 3,236 | 448 | 30,532 |
| SSA-2 | 346 | 2,868 | 3,532 | 30,748 | 2,800 | 440 | 33,988 |
| SSA-3 | 1,029 | 20,380 | 9,698 | 57,142 | 4,308 | 635 | 62,085 |
| SSA-4 | 622 | 31,088 | 3,235 | 28,377 | 3,608 | 528 | 35,748 |

As the table shows, the size of FIRMWARE increases as the SSA gets more complicated and needs more services. Nevertheless, the run-time software TCB (SSA and FIRMWARE combined) of SSA-3, which is a functional digital right management music player, has only 10,727 SLOC, representing a significant software TCB reduction from the 277K SLOC of the OP-TEE and the 27.8M SLOC of the Linux kernel [15].

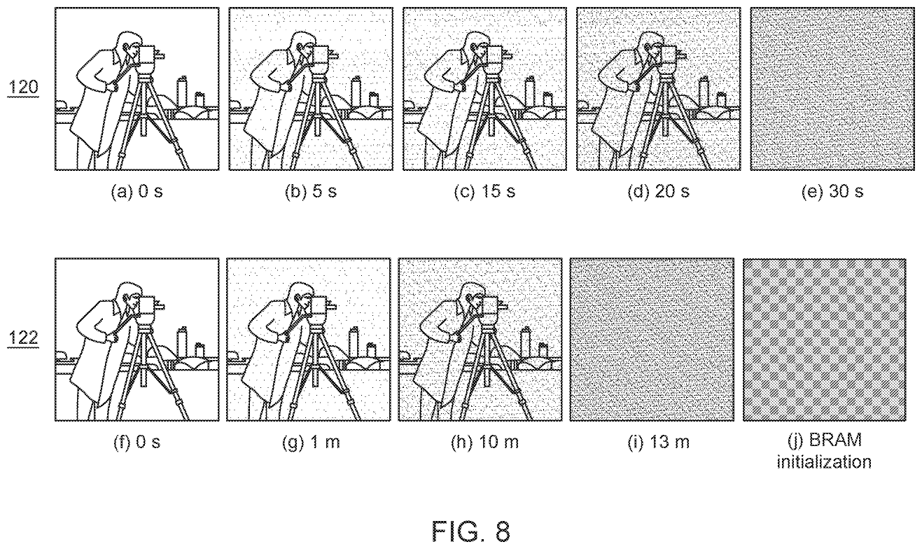

FIG. 8 is a visual diagram of DRAM decay after power down and BRAM hardware initialization after power up on the same Z7-07S board. A bitmap image (150×150 pixel; 90.1 kB) is loaded on the DRAM and BRAM. As shown in row 120, then a measure is taken of DRAM decay at room temperature (20° C./68° F.) after (a) power reset (0 second) and (b)-(e) losing power for different intervals; 2) DRAM decay at −18° C./0° F. after (f) power reset and (g)-(i) losing power for different intervals; and 3) (j) BRAM hardware initialization after power up. The reconstructed image from the fully decayed DRAM is red, because half of the cells are measured as 1s and the other half as 0s. The reconstructed image from the BRAM is transparent, because all the bits are initialized to 0s.

Cold-boot attacks on DRAM are a serious problem, especially when an attacker has the physical access to the device. Thus, the feasibility of cold-boot attacks on DRAM and BRAM on the same Cora Z7-07S board was evaluated. In these experiments, a bitmap image was onto DRAM and BRAM and, as shown in row 122, the DRAM decay was measured at room temperature (20° C./68° F.) and −18° C./0° F. after power reset (0 second) and losing power for different intervals. The content of BRAM was dumped, for which the Xilinx Zynq-7000 FPGA has a non-bypassable hardware initialization mechanism after power up to clear all the bits to 0s. Here, even if the BRAM is not initialized, cold-boot attacks on it are much more difficult than on DRAM. FIG. 9 visualizes the cold-boot attack results, which clearly shows cold-boot attacks on DRAM is feasible but not on BRAM.

To evaluate the performance of the MicroBlaze-powered CTEEs using 12 Embench-IoT benchmark applications. To show the performance of the MicroBlaze softcore compared to the Cortex-A hardcore in our implementation, 12 applications from the Embench-IoT benchmarks are used, which is a benchmark suite designed to test performance of embedded systems with the assumptions of no OS, minimum C library support, and no output stream.

Table 4 shows an Embench-IoT benchmark performance evaluation on Cortex-A and MicroBlaze (in millisecond). The numbers in the parentheses represent slow-down percentage on MicroBlaze compared to Cortex-A.

TABLE 4

| Application | Description | Cortex-A | MicroBlaze | |
|---|---|---|---|---|
| aha-mont64 | Modulo generator | 0.04 | 1.18 | (2752.65%) |
| crc_32 | 32 bit error detector | 0.09 | 1.87 | (1988.30%) |
| huffbench | Data compressor | 1.21 | 4.97 | (411.71%) |
| minver | Floating point matrix in- | 3.42 | 293.04 | (8568.42%) |
| | version | | | |
| nettle-aes | Low level AES library | 0.23 | 3.14 | (1394.84%) |
| nsichneu | Computes permutation | 8.70 | 58.56 | (672.85S %) |
| prinmecount | Prime counter | 15.09 | 89.86 | (595.59%) |
| sglib-xcombined | Sort, search and query | 15.83 | 114.33 | (722.22%) |
| | on array, list, and tree | | | |
| slre | Regex matching | 9.55 | 127.26 | (1332.57%) |
| statemate | Car window lift control | 3.52 | 29.59 | (839.67%) |
| tarfind | Archive file finder | 13.81 | 189.46 | (1371.91%) |
| ud | Matrix factorization | 14.06 | 235.11 | (1671.99%) |

As Table 4 shows, the same application is 4 to 27 times slower when running on the softcore MicroBlaze 100 MHz processor than on the hardcore Cortex-A 667 MHz processor on the same board. Since the MicroBlaze softcore does not have a floating point unit, the minver benchmark application for floating point matrix inversion has an 85 times slow down. Note that as a framework, BYOTEE supports the deployment of other powerful softcore CPUs, such as RISC-V, if the FPGA hardware supports.

The present invention can also be implemented in a GPGPU environment, which stands for “general-purpose computing on graphics processing units”, or “general-purpose graphics processing units” for short. The idea is to leverage the power of GPUs, which are conventionally used for generating computer graphics, to carry out tasks that were traditionally done by central processing units (CPU). The combined use of these two kinds of processors is sometimes referred to as heterogeneous computing; it is a key factor in a lot of technological breakthroughs, such as the development of artificial intelligence through machine learning and deep learning.

GPGPUs excel at parallel computing due to their large number of cores, which operate at lower frequencies than CPUs, but are more suited for data that's in graphical form. Groundbreaking scientific research can benefit greatly from GPGPUs, and many high performance computing (HPC) servers utilize a large number of GPGPUs to reach the level of supercomputing.

The present system can therefore also be embodied as an open-core GPGPU MIAOW, which is available in the register-transfer level (RTL) form and prototyped in the FPGA. As explained earlier, since the SA adopts the AXI bus protocol to connect with applications, MIAOW, which is already designed for AXI, can be plugged intact into a TEE. MIAOW is compatible with a subset of AMD's Southern Islands ISA, and it supports the OpenCL programming model widely used for general heterogeneous parallel computing. MIAOW RTL code is synthesized and implemented into the bitstream that fits into a dynamic region so that it can be installed it as an application upon a user's request. Once MIAOW hardware is loaded, multiple compute units are instantiated as a parallel processing engine, and buffers named local data share (LDS) and global data share (GDS) are included for storing data. The remote user can execute the original GPU code targeted at MIAOW without tailoring it. The remote user transfers the code/data to the SA within the FPGA 14 and then transmits a trigger signal to run the user's GPU code on MIAOW. The communication channel between the user and MIAOW can be protected securely by the SA, so this embodiment of the TEE can overcome the main security concern (protecting the privacy of the user's data) in a GPGPU-based service such as Machine Learning as a Service (MLaaS).

With reference again to FIG. 1, it can thus be seen that present invention provides an inventive method for building a TEE for software programs can include configuring a plurality of computing resources on a SOC semiconductor substrate 10 including a plurality of electronic components, configuring a processing system 12 located on the semiconductor substrate 10 including one or more processors, configuring a FPGA 14 that is located on the semiconductor substrate 10 and in communication with the processing system, the FPGA 14 configured to implement one more soft processors to create one or more TEEs for a software program process to execute within, and configuring each TEE to allow a software program to execute in a secure manner wherein the software program is isolated from, at least, the full plurality of computing resources of the semiconductor substrate 10. The method can include further configuring the FPGA 14 within a block random access memory 36, and further configuring the FPGA 14 with a bitstream programmed in a hardware design description language.

In another embodiment, the method can further include configuring the FPGA 14 to support a secure boot of a software program that includes firmware by loading that software program onto the processing system and the bitstream, and loading any firmware within that software program onto the FPGA 14 in a TEE. The method can also include configuring the FPGA 14 to include a cryptographic layer, as shown in FIG. 4.

In one embodiment, where the semiconductor substrate 10 is within a server, the method includes hosting one or more data processes at the server from remote users, and then implementing a graphics processing unit module within the bitstream. Then the method further includes implementing a GPGPU environment as the TEE.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A system for building a trusted execution environment for software programs, comprising:
a semiconductor substrate including a plurality of electronic components with a plurality of computing resources;
a processing system located on the semiconductor substrate including one or more processors; and
a field programmable gate array located on the semiconductor substrate and in communication with the processing system, the field programmable gate array configured to implement one more soft processors to create one or more trusted execution environments for a software program process to execute within, with each trusted execution environment configured to allow a software program to execute in a secure manner wherein the software program is isolated from, at least, the full plurality of computing resources of the semiconductor substrate.

2. The system of claim 1, wherein the field programmable gate array is comprised of block random access memory.

3. The system of claim 2, wherein the field programmable gate array is further configured with a bitstream programmed in a hardware design description language.

4. The system of claim 3, wherein:
the software program can include firmware; and
the field programmable gate array is further configured to support a secure boot that:
loads a software program onto the processing system and the bitstream; and
loads any firmware within the software program onto the field programmable gate array in a trusted execution environment.

5. The system of claim 1, wherein the field programmable gate array includes a cryptographic layer.

6. The system of claim 1, wherein the semiconductor substrate is within a server hosting one or more data processes from remote users.

7. The system of claim 3, wherein the bitstream implements a graphics processing unit module.

8. The system of claim 7, wherein the trusted execution environment is a general-purpose computing on graphics processing units (GPGPU) environment.

9. A method for building a trusted execution environment for software programs, comprising:
configuring a plurality of computing resources on a semiconductor substrate including a plurality of electronic components;
configuring a processing system located on the semiconductor substrate including one or more processors;
configuring a field programmable gate array that is located on the semiconductor substrate and in communication with the processing system, the field programmable gate array configured to implement one more soft processors to create one or more trusted execution environments for a software program process to execute within; and
configuring each trusted execution environment to allow a software program to execute in a secure manner wherein the software program is isolated from, at least, the full plurality of computing resources of the semiconductor substrate.

10. The method of claim 10, further configuring the field programmable gate array within a block random access memory.

11. The method of claim 10, further configuring the field programmable gate array with a bitstream programmed in a hardware design description language.

12. The method of claim 11, wherein:
further configuring the field programmable gate array to support a secure boot of a software program can include firmware;
loading a software program onto the processing system and the bitstream; and
loading any firmware within the software program onto the field programmable gate array in a trusted execution environment.

13. The method of claim 10, further configuring the field programmable gate array to include a cryptographic layer.

14. The method of claim 10, wherein the semiconductor substrate is within a sever, and further comprising hosting one or more data processes at the server from remote users.

15. The method of claim 11, further comprising implementing a graphics processing unit module within the bitstream.

16. The method of claim 15, further comprising implementing a general-purpose computing on graphics processing units (GPGPU) environment as the trusted execution environment.

17. A system for building a trusted execution environment for software programs, comprising:
a computing means on a semiconductor substrate for providing a plurality of computing resources, the computing means including a plurality of electronic components;
a processing means located on the semiconductor substrate including one or more processors, the processing means for processing, at least, software programs within the plurality of computing resources within the computing means; and
a memory means located on the semiconductor substrate and in communication with the processing means, the memory means for implementing one more soft processors thereby creating one or more trusted execution environments for a software program process to execute within, the memory means further configuring each trusted execution environment to allow a software program to execute in a secure manner wherein the software program is isolated from, at least, the full plurality of computing resources of the computing means.

18. The system of claim 16, further including a server means for hosting one or more data processes from remote users.

19. The system of claim 16, wherein the memory means further creating a cryptographic layer.

20. The system of claim 16, wherein the memory means further creating a general-purpose computing on graphics processing units (GPGPU) environment as the trusted execution environment.
